(19) United States
(12) Patent Application Publication
(10) Pub. No.: US 2018/0052778 A1
(43) Pub. Date: Feb. 22, 2018

(54) INCREASE CACHE ASSOCIATIVITY USING HOT SET DETECTION

(71) Applicant: Advanced Micro Devices, Inc., Sunnyvale, CA (US)

(72) Inventors: John Kalamatianos, Boxborough, MA (US); Adithya Yalavarti, Boxborough, MA (US); Johnsy Kanjirapallil John, Acton, MA (US)

(73) Assignee: Advanced Micro Devices, Inc., Sunnyvale, CA (US)

(21) Appl. No.: 15/243,921

(22) Filed: Aug. 22, 2016

(51) Int. Cl. G06F 12/12; G06F 12/0864; G06F 12/0893; G06F 12/0891

(52) U.S. Cl. CPC G06F 12/12; G06F 12/0864; G06F 2212/69; G06F 12/0891; G06F 2212/60; G06F 12/0893

(57) ABSTRACT

A processing apparatus and a method of accessing data using cache hot set detection is provided that includes receiving a plurality of requests to access data in a cache. The cache includes a plurality of cache sets each including N number of cache lines. Each request includes an address. The apparatus and a method also includes storing, in a HSVC array, cache line victims of one or more of the plurality of cache sets determined to be hot sets. Each cache line victim includes a corresponding address that is determined, using a HSD array, to belong to the one or more determined cache hot sets based on a hot set frequency of a plurality of addresses mapped to the set in the cache.

### BACKGROUND

Cache memory is a memory type used to accelerate access to data stored in a larger memory type (e.g., main memory in a computer) by storing copies of data in the cache that are frequently accessed in portions of the larger memory. When a processor requests access to (e.g., read from or write to) data in a portion (e.g., identified by an address) of the larger memory (hereinafter memory), the processor first determines whether a copy of the data is stored in the cache. If so, the processor accesses the cache, facilitating a more efficient accessing of the data.

Frequently accessed data is copied between the memory and the cache in blocks of a fixed size, typically referred to as cache lines. When a cache line is copied to the cache, a cache entry is created, which includes the copied data and the requested memory address, referred to hereinafter as a tag. If the tag is found in the cache, a cache hit occurs and the data is accessed in the cache line. If the tag is not found in the cache, a cache miss occurs. A new entry is allocated to the cache, data from the larger memory is copied to the cache and the data is accessed.

Existing entries are replaced (e.g., victimized) by new entries according to different mapping policies. Policies include a fully associative policy in which new entries are copied in any cache address or a non-associative (direct mapping) policy that allocates one address in the cache for each entry. Most conventional caches utilize an N-way set associative policy in which each entry is allocated to a set containing N number of cache lines, where each line holds the data from any tag. The larger the N number of lines, the greater the associativity and the lower the probability for cache misses. The increase in associativity, however, includes a greater number of addresses to search, and therefore, results in more latency, higher power and a larger storage area.

### BRIEF DESCRIPTION OF THE DRAWINGS

A more detailed understanding can be had from the following description, given by way of example in conjunction with the accompanying drawings wherein:

FIG. 1 is a block diagram of an example device in which systems, apparatuses, and methods disclosed herein are implemented;

FIG. 2 is a block diagram illustrating an exemplary information flow and interconnectivity of a portion of an exemplary hot cache processing device;

FIG. 3 is a flow diagram illustrating an exemplary method of accessing data using cache hot set detection;

FIG. 4 is a flow diagram illustrating an exemplary method of accessing data using cache hot set detection via a virtual extension to associativity of cache hot sets; and

FIG. 5 is a flow diagram illustrating an exemplary method of accessing data using cache hot set detection via a unified replacement array.

### DETAILED DESCRIPTION

Typically, there is an uneven distribution of hits and misses in a cache across its sets. The uneven distribution is caused by a number of factors regarding how the cache is accessed and is more pronounced in a shared cache because the shared cache services, for example: both instruction and data accesses; accesses (data or instruction) from different threads; data accesses of the same thread from different data structures simultaneously and both demand and pre-fetch traffic. If the shared cache is physically indexed, then the operating system (OS) page placement policies typically lead to uneven distribution of hits and misses. This uneven distribution occurs for inclusive, exclusive and semi-inclusive caches. Some conventional methods attempt to compensate for the uneven distribution by employing sophisticated hashing to spread accesses across the cache sets more evenly or alternative cache organizations to mimic higher degrees of associativity.

Systems, apparatuses and methods described herein dynamically determine whether cache sets are “hot,” based on a frequency of addresses mapped to each of the sets. Metrics used to determine the frequency (e.g., measured over a period of time or a number of clock cycles), include for example: a number of per set accesses (hits and misses), misses, predictions, or mis-predictions; a percentage (or ratio) of per set accesses (hits or misses), misses, predictions, or mis-predictions of multiple cache sets, including each of the cache sets. The determination of hot sets adapts to a changing metric over time for a given set. High cache associativity or a larger number of victim buffers is provided for cache subsets determined to be hot sets, thereby reducing the probability of cache misses.

Systems, apparatuses and methods are provided which extend the associativity of hot sets using a set-associative array (e.g., table) to provide an extension of the cache's associativity without extending the critical cache hit flow. Higher associativity is achieved by tracking hot cache sets and mapping a set of extra cache lines, stored in the associative table, to each hot set. The replacement state bits of the cache and the small associative table is organized so that the cache and the table function together with higher associativity when accessing the hot sets.

Systems, apparatuses and methods are provided which determine hot sets as sets having an access (or misses, predictions, mis-predictions or other metric) frequency equal to or greater than a percentage of the accesses (or other metric) to the cache. An extension of the cache's associativity is provided without extending the critical cache hit flow.

Conventional victim caches are typically non-scalable, fully associative caches where each entry is searched to accommodate victims from each of the cache sets. Apparatuses and methods are provided that utilize a set associative hot set victim cache (HSVC) which tracks victims of hot cache sets having exclusive access to the victim cache. Hot sets change over time and adapt to workload behavior. Accessing data using cache hot set detection includes implementing the HSVC as a virtual extension to the cache's hot sets associativity, such that the cache array and the HSVC array provide a unified replacement array to control the replacement across the cache array and the HSVC array when the arrays are accessed simultaneously.

A method of accessing data using cache hot set detection is provided that includes receiving a plurality of requests to access data in a cache including a plurality of cache sets each including N number of cache lines. Each request includes an address. The method also includes storing, in a hot set victim cache (HSVC) array, cache line victims of one or more of the plurality of cache sets determined to be hot sets. Each cache line victim includes a corresponding address that is determined, using a hot set detector (HSD) array, to belong to the one or more determined cache hot sets based on a hot set frequency of a plurality of addresses mapped to the set in the cache.

A processing apparatus is provided that includes memory and one or more processors in communication with the memory. The memory includes a cache having a plurality of cache sets each including N number of cache lines, a hot set detector (HSD) array and a hot set victim cache (HSVC) array. The one or more processors are configured to receive a plurality of requests, including the address, to access data in the cache. The one or more processors are also configured to store, in the HSVC array, cache line victims of one or more of the plurality of cache sets determined to be hot sets. Each cache line victim includes a corresponding address that is determined, using a hot set detector (HSD) array, to belong to the one or more determined cache hot sets based on a hot set frequency of a plurality of addresses mapped to the set in the cache.

A tangible, non-transitory computer readable medium is provided that includes instructions for causing a computer to execute a method of accessing data using cache hot set detection. The instructions include receiving a plurality of requests to access data in a cache. The cache includes a plurality of cache sets each including N number of cache lines. Each request includes an address. The instructions also include storing, in a hot set victim cache (HSVC) array, cache line victims of one or more of the plurality of cache sets determined to be hot sets. Each cache line victim includes a corresponding address that is determined, using a hot set detector (HSD) array, to belong to the one or more determined cache hot sets based on a hot set frequency of a plurality of addresses mapped to the set in the cache.

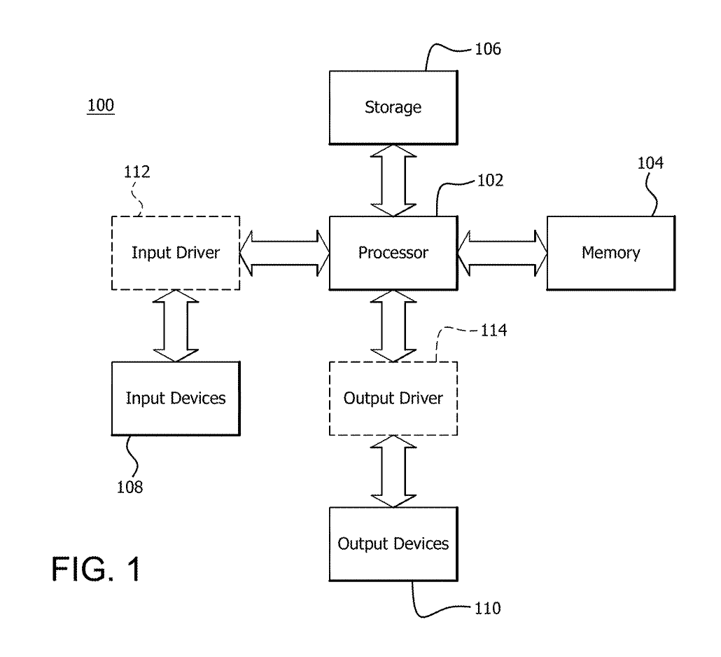

FIG. 1 is a block diagram of an example device 100 in which accessing data using cache hot set detection is implemented. The device 100 includes, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 also includes an input driver 112 and an output driver 114. It is understood that the device 100 can include additional components not shown in FIG. 1.

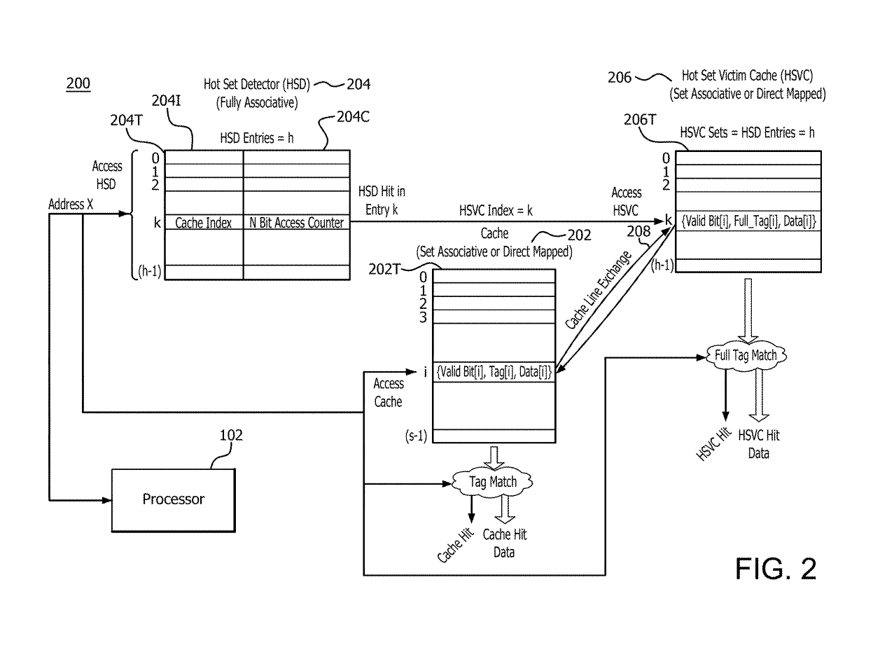

Processor types for processor 102 include a central processing unit (CPU), a graphics processing unit (GPU), a CPU and GPU located on the same die, or one or more processor cores, wherein each processor core is, for example, a CPU or a GPU. The memory 104 can be located on the same die as the processor 102 or separate from the processor 102. Memory types for memory 104 include volatile and non-volatile memory, for example, random access memory (RAM), dynamic RAM and cache memory, such as cache 202, HSD 204 and a hot set victim cache HSVC 206 shown in FIG. 2.

Types of storage 106 include fixed and removable storage, for example, a hard disk drive, a solid state drive, an optical disk, or a flash drive. Types of input devices 108 include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). Types of output devices 110 include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present.

FIG. 2 is a block diagram illustrating an exemplary information flow and interconnectivity of a portion of a processing apparatus 200 used for hot set detection. As shown in FIG. 2, the processing apparatus 200 includes cache 202, HSD 204 and HSVC 206 and processor 102 (shown in FIG. 1). Processor 102 is in communication with cache 202, HSD 204 and HSVC 206.

The cache 202, HSD 204 and HSVC 206 are portions of memory 104 shown in FIG. 1. For example, cache 202, HSD 204 and HSVC 206 are portions of cache memory located on the same die as the processor 102. Alternatively, cache 202, HSD 204 and HSVC 206 are portions of cache memory located separate from the processor 102.

Examples of cache 202, HSD 204 and HSVC 206 include memory portions dedicated to a single processor (e.g., a CPU, a GPU, or a processor core) and memory portions shared by any number of processors (e.g., shared by multiple CPUs, shared by multiple GPUs, shared by at least one CPU and at least one GPU, or shared by multiple processor cores). FIG. 2 illustrates one cache 202, one HSD and one HSVC in communication with processor 102. The numbers of these memory portions shown are merely exemplary.

As shown in FIG. 2, the array data structures of cache 202, HSD 204 and HSVC 206 are illustrated using tables to describe implementations of the hot cache processing device 200. For example, the array data structures illustrated include cache table 202T, HSD table 204T and HSVC table 206T. The tables shown in FIG. 2 are exemplary. Although cache 202, HSD 204 and HSVC 206 are shown and described as tables, examples of these memory portions include any suitable data structure to facilitate the processing of data described herein.

Cache 202 is configured store any payload, such as for example, instructions, micro-operations (uops), data, branch targets for branch address prediction, load addresses for address speculation, values for value prediction, memory dependencies for dependence prediction, and address translations. As shown in FIG. 2, cache array 202T includes a plurality of cache sets (0−(s−1)). The cache 202 utilizes an N-way set associative policy (or direct mapping). That is, each address is mapped to a cache set containing N number of cache lines, where each line holds the data from any address mapped to that set. Accordingly, each cache set 0−(s−1) includes N number of entries each including a valid bit, a tag (i.e., address mapped to the cache 202) and the copied data. If a hit occurs (tag is determined to be in the cache 202), the processor 102 provides the requested data to the requestor. If a miss occurs, the processor 102 searches for the tag in the next level cache.

The processor 102 uses the HSD array 204T to determine whether an address (e.g., address X) accessing the cache array 202T belongs to a set of the cache array 202T that is “hot,” referred to hereinafter as hot address. A set is determined to be “hot” based on a frequency of addresses accessing the set (i.e. a hotness frequency). For example, a set is determined to be “hot” when a hot set frequency value (e.g., number of hot addresses accesses, ratio or percentage of hot address accesses to cache address accesses) is greater than or equal to a hot set frequency threshold value (e.g., predetermined number of hot addresses accesses, predetermined ratio or percentage of hot address accesses to cache address accesses). Exemplary measurements of the hotness frequency include: when a predetermined number of addresses accessing the cache array 202T occurs; for an interval (e.g., one or more clock cycles); upon the occurrence of an event or upon request. An address mapped to the cache array 202T includes, but is not limited to a cache hit (e.g., matching address), a cache miss (e.g., cold-start miss, capacity miss, a conflict miss), a prediction, and a mis-prediction.

As shown in FIG. 2, the HSD array 204T includes a plurality of entries (0−(h−1)) allocated to each address accessing the HSD array 204T. Each of the entries (0−(h−1)) includes a portion (e.g., portions in column 2041) holding the index bits (CACHE INDEX) of an address mapped to the cache set pointed by the same index bits in cache array 202. Because the HSD 204 is fully-associative, the index bits of each of the addresses accessing cache array 202T are stored as the tag in each HSD entry (0−(h−1)). Addresses are either virtual or physical depending on the cache indexing scheme. When the index bits of the address match the tag of an entry stored in the HSD array 204T (e.g., CACHE INDEX of kth entry), it is determined that the address accessing the cache array 202T belongs to a set of the cache array 202T that is hot.

As shown in FIG. 2, each of the HSD entries (0−(h−1)) also includes an N-bit up/down saturation counter at portions illustrated by column 204C. When an HSD hit occurs, the counter for a corresponding HSD entry is incremented. For example, when the index bits of address X (shown in FIG. 2) match the index bits indicated by CACHE INDEX shown in the first portion of the kth entry, the counter for the kth entry is incremented. Alternatively, the counter starts at a predetermined level and be decremented.

Invalid entries are also be determined and will be filled in the HSD array 204T in the case of a HSD tag miss. If there are no invalid entries for the HSD array 204T and no tag match for the address X, the counter for each entry is decremented. When a counter for a corresponding HSD entry reaches a predetermined value (e.g., zero), the HSD entry is replaced by storing the index bits of the new address and the counter for the new HSD entry is incremented.

The processor 102 dynamically configures the HSD array 204T to determine which addresses, accessing the cache array 202T, belong to a cache array 202T hot set, using a bounded number of HSD entries that depends on a hot set frequency threshold value. For example, for a hot set frequency threshold value of 4% of the addresses mapped to the cache 202, the processor 102 dynamically configures the HSD table 204T to have 25 entries (25 counters×4%=100%) or less. In an example, the hot set frequency threshold value is set such that the number of HSD entries is a power of 2. The hot set frequency threshold value is dynamically determined. Alternatively, the hot set frequency threshold value is static. For example, if the predetermined threshold value is 3.125%, 32 HSD entries are generated. At reset, the HSD counters for each entry is set to a predetermined value (e.g., zero value) and each entry maybe set to invalid.

Hot set frequency threshold values are dynamically determined (e.g., according to one or more application instructions or header information, estimated cache size to be used to execute an application and other cache parameters) and, alternatively, determined prior to processing of data (e.g., prior to executing a portion of an application). Metrics used to determine the hot set frequency threshold (e.g., measured over a period of time or a number of clock cycles), include for example: a number of per set accesses (hits and misses), misses, predictions, or mis-predictions; a percentage (or ratio) of per set accesses (hits), misses, predictions, or mis-predictions of multiple cache sets (e.g., total number of the cache sets). Because the HSD array 204T is used to track the number of hot sets using the hot set frequency threshold, the number of HSD entries is independent from the number of cache sets of array 202T.

The HSVC array 206T stores line victims of determined hot sets in the cache. For example, the processor 102 is configured to use the HSVC array 206T to store entry victims (via the top cache line exchange arrow 208 shown in FIG. 2) of overflowing hot sets of the cache array 202T without storing entry victims of other non-hot sets of the cache array 202T. That is, the HSVC array 206T is different from a conventional victim cache because the HSVC array 206T is used to store victims of the hot sets of the cache array 202T and not victims of each of the sets in the cache array 202T. As shown in FIG. 2, HSVC table 206T includes a plurality of HSVC sets (0−(h−1)). Each HSVC set (0−(h−1)) includes a valid bit, a tag and copied data. When a large number of addresses access the same cache set, one or more entries are evicted from the overflowing hot cache set of the cache array 202T.

The HSVC array 206T includes a number of sets equal to the number of HSD entries so that the hot cache sets tracked by HSD are mapped to the HSVC sets on a one-to-one basis. The HSVC array 206T is set associative when the HSVC tags include the cache tag and index bits together because the HSVC set is selected by the HSD hit index. The associativity of the HSVC array 206T includes the same associativity as the cache 202, or alternatively, includes its own unique associativity that is less than or greater than the cache array 202T.

Because the HSD hit index is used to select the HSVC set, when an HSD entry is replaced, the modified lines of the corresponding HSVC set are flushed to maintain coherency. The HSVC set is not flushed if the HSVC array 206T includes non-coherent payloads (e.g., instructions, branch targets, load targets, and the like) or coherent payloads that are not modified.

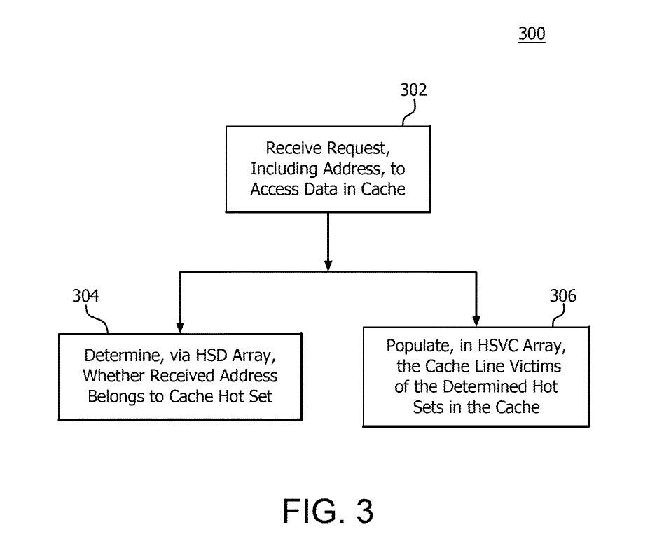

FIG. 3 is a flow diagram illustrating an exemplary method 300 of accessing data using cache hot set detection. As shown at block 302 of FIG. 3, the method 300 includes receiving a request, including an address, to access data in a cache. For example, a request, including address X, to access data in cache array 202T is received by one or more processors (e.g., processor 102). The requested data can correspond to the address of another memory portion, such as for example, an address in a larger memory (e.g., main memory). The address is then mapped to the cache array 202T to determine whether the address is in the cache array 202T.

As shown at block 304 of FIG. 3, the method includes determining, via an HSD array, whether the requested address belongs to a set in the cache determined to be a hot set. Hot sets are determined based on a frequency of addresses mapped to each of the plurality of sets in the cache 202. For example, as described above, hot sets are determined using a bounded number of entries in the HSD array 204T that depend on a hot set frequency threshold value. Each of the entries in the HSD array 204T includes the cache index of entries that correspond to hot sets of the cache array 202T. When the index bits of the newly received address (e.g., address X in FIG. 2) match the index bits of an entry stored in the HSD array 204T (i.e., an HSD hit occurs), the newly received address is determined to belong to a hot set in the cache array 202T.

As further shown at block 306 of FIG. 3, the method also includes using the one or more processors to populate, in an HSVC array, the cache line victims of the determined hot sets in the cache array 202T. Blocks 304 and 306 are shown in FIG. 3 as being performed in parallel with each other. Blocks 304 and 306 can, however, be performed sequential to each other and in any order.

Exemplary management of the HSVC array 206T and the cache array 202T is implemented as follows.

When an address hits in the cache array 202T, the cache is accessed and the data is returned to the requestor independent of whether the cache set is hot or cold. No additional latency is added to the hit flow. The HSD 204 is accessed and updated in parallel with the access to the cache array 202T, but the HSVC 206 is not accessed.

When an address misses in the cache array 202T and hits in the HSD array 204T (indicating address X belongs to a hot set) the HSVC array 206T is accessed. When the address misses in the HSVC array 206T, a line is victimized from the hot set of the cache array 202T to the HSVC array 206T (indicated by the top cache line exchange arrow 208 in FIG. 2) and the new data corresponding to address is stored in the cache array 202T. When the HSVC set is full, a victim line is selected and evicted. The selected line is evicted to the next level cache (e.g., based on an inclusion property of the next level cache or coherency due to modification).

After accessing the HSVC array 206T, when the address hits in the HSVC array 206T, a line victim from the cache 202 is exchanged (swapped) with the line hit in the HSVC array 206T. That is, the line is evicted from the cache 202 to the HSVC array 206T (indicated by the top cache line exchange arrow 208 shown in FIG. 2) and the line hit in the HSVC array 206T is populated in the cache array 202T (indicated by the bottom line exchange arrow 208 shown in FIG. 2).

When an address misses in the cache 202 and misses in the HSD 204 (indicating address X does not belong to a hot set), address X also misses in the HSVC 206 (no need to access HSVC array 206T to verify miss) because the HSVC 206 is mutually exclusive of the cache 202. This case is handled as a normal cache miss and the new line is placed into the cache array 202 as usual. Any line victimized from the cold set of cache array 202 is evicted to the next level cache and is not stored in the HSVC array 206.

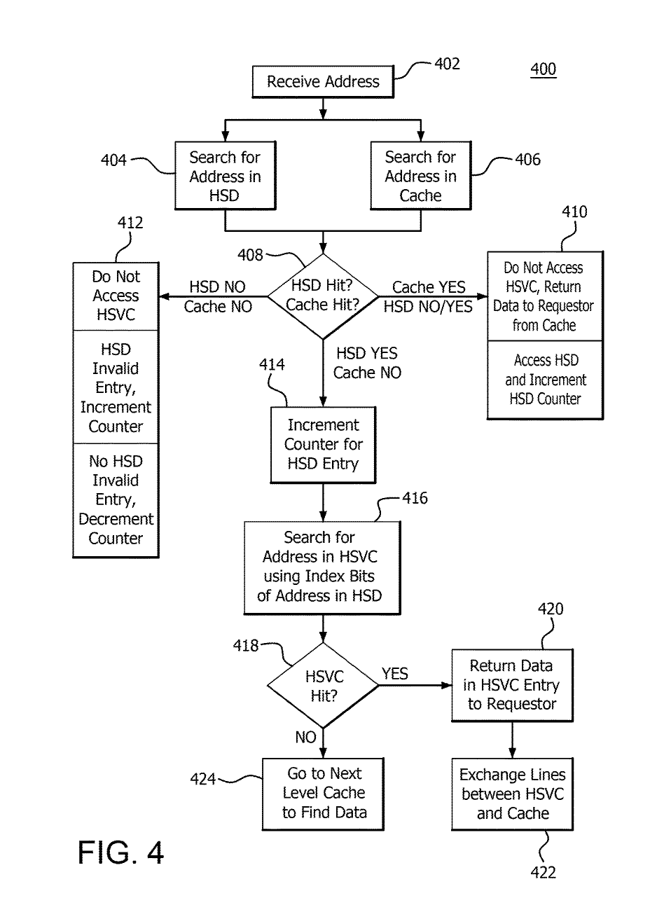

FIG. 4 is a flow diagram of an exemplary method 400 of accessing data using cache hot set detection in which the HSD array 204T and cache array 202T are accessed in parallel prior to accessing the HSVC array 206T. In this implementation, the HSVC array 206T utilizes the determined hot sets to provide a virtual extension to the cache's hot sets associativity independent from the total sets in the cache. Further, the cache's hot set associativity is extended without extending the cache hit latency.

The method 400 is described with reference to FIG. 2. As shown at block 402 of FIG. 4, the method 400 includes receiving an address (e.g., address X shown in FIG. 2) which is mapped to the cache array 202T. For example, processor 102 receives a request to access data corresponding to the address of another memory portion, such as for example, an address in a larger memory (e.g., main memory). The address then accesses the cache array 202T to determine whether the address is in the cache array 202T.

As shown at blocks 404 and 406 of FIG. 4, the method 400 includes accessing both the HSD array 204T and the cache array 202T in parallel by searching for the address in both the cache array 202T and the HSD array 204T. For example, when the address is received, the HSD array 204T is searched using the index bits of the address (e.g., index is log2(s), where s is the number of cache sets).

The HSD array 204 is searched, for example, using the index bits of address X (shown in FIG. 2). The cache array 202T is accessed using the address X.

As shown at decision block 408 of FIG. 4, the method 400 includes determining whether there is an HSD hit and a cache hit. When it is determined that the address is in the cache array 202T, a cache hit occurs. As described above, each of the entries in the HSD array 204T includes the cache index of hot sets of the cache array 202T. Accordingly, when the index bits of the address match the index bits of an entry stored in the HSD array 204T, an HSD hit occurs, and it is determined that the received address belongs to a hot set in the cache array 202T. For example, when the index bits of address X (shown in FIG. 2) match the index bits of the kth entry (indicated by CACHE INDEX shown in the first portion of the kth entry) of the HSD array 204T, an HSD hit occurs and address X is determined to belong to a hot set in the cache array 202T.

When it is determined that the address is in the cache array 202T regardless of whether there is an HSD hit or miss (i.e., CACHE YES, HSD NO/YES), the HSVC array 206T is not accessed and the data is returned from the cache array 202T to the requestor, as shown at block 410 in FIG. 4. For example, when address X is determined to be in a set of the cache array 202T, regardless of whether the cache set is hot or cold, a cache hit occurs and the data in the cache entry is returned to the requestor.

Further, when the cache hit occurs and it is also determined that there is an HSD hit, the HSD array 204T is accessed and updated, which is also shown in the bottom part of block 410 in FIG. 4. For example, the counter of the kth entry is incremented. The data is returned from the cache array 202T to the requestor. The HSD array 204T is also updated if there is an HSD miss (e.g., each counter is decremented).

When it is determined that the address is not in the HSD array 204T and is also not in the cache array 202T (HSD NO, CACHE NO), the HSVC array 206T is not accessed, as shown at block 412 in FIG. 4 and the data is not returned. Also, when there is an HSD miss and an invalid entry is determined in the HSD 204, the entry is populated in the HSD table 204T and the counter is incremented for the entry, as shown in the middle part of block 412. When an invalid entry is not determined in the HSD 204 and there is an HSD miss, the counter for every HSD table entry is decremented, as shown in the bottom part of block 412. When a counter of an HSD entry reaches a predetermined value (e.g., zero), the invalid HSD entry becomes invalid and used to store the index bits of the received address. The counter for the new HSD entry is incremented.

When it is determined that the address is not in the cache array 202T, but is in the HSD array 204T (HSD YES, CACHE NO), an additional opportunity to return the data from the HSVC array 206T is provided as shown in blocks 414 to 422 in FIG. 4, in which the HSVC array 206T is accessed sequentially to the cache array 202T.

As shown at block 414 in FIG. 4, because there is an HSD hit (e.g., hit in the kth entry shown in FIG. 2), the HSD array 204T is accessed, the counter of the kth entry is incremented and the kth set is accessed in the HSVC array 206T using the value k as the index in the HSVC array 206T.

When an HSD hit occurs and a cache miss occurs, the HSVC array 206T is accessed and its set is searched, as shown at block 416, to determine if the newly received address is in the HSVC array 206T.

As shown at decision block 418 of FIG. 4, the method 400 includes determining whether there is an HSVC hit. An HSVC hit occurs when the tag bits of the newly received address matches any of the tag bits stored in the different lines of the HSVC array 206T's kth set (k is the index of the HSD entry where the address hit). The tag width of the HSVC entries is different from the tag width of the cache array 202T because the associativity and size of the HSVC is different than that of the cache array 202T.

When an HSVC hit occurs, the data in the HSVC entry is returned to the requestor, as shown at block 420 and a line victim from the cache 202 is exchanged (swapped) with the line hit in the HSVC array 206T, as shown at block 422. The latency is implementation dependent, but in an alternative, is made equal or substantially equal to the cache hit latency if the HSD and HSVC are smaller arrays. An HSD hit does not imply a hit in HSVC because an HSD is triggered by a cache array 202T index match while an HSVC hit is triggered by a full address match. The data can also be exchanged between the HSVC entry where it resides and the cache array 202T set where it missed so that next time a request arrives on the same address, it will hit from the cache array 202T. A confidence counter in the HSVC entry is used to decide on whether to exchange data or not.

The cache array 202T can be backed by another cache (e.g., L2 cache). Accordingly, when an HSVC miss occurs, the data is searched for in the next level cache (if available), as shown at block 422. Otherwise, the data is returned by main memory.

Because there is a cache array 202T and a separate HSVC array 206T, each array has its own replacement policy. Accordingly, a cache array 202T to HSVC array 206T victim flow and a HSVC array 206T to cache array 202T is provided and is activated on HSD hits and not HSD misses. The HSVC array 206T behaves similar to a victim cache. Because the HSD hit index is used to select the HSVC set, when an HSD entry is replaced (its counter reaches the threshold value of 0), the modified lines of the corresponding HSVC set are flushed to the next level of cache or main memory to maintain coherency.

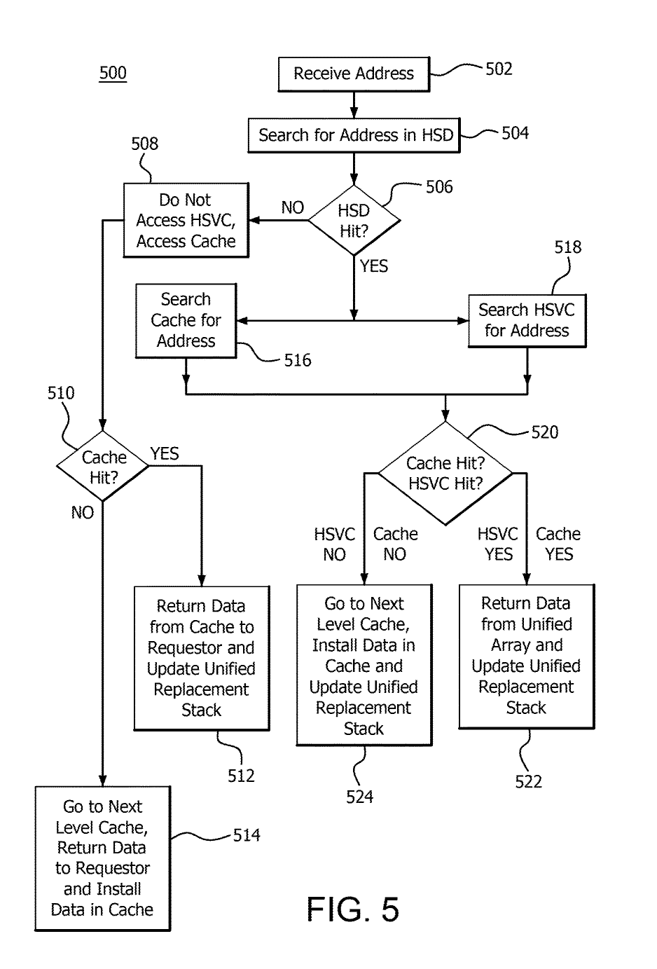

FIG. 5 is a flow diagram illustrating an exemplary method 500 of implementing the method 300 shown in FIG. 3 by using a unified replacement array. In the method 500 shown in FIG. 5, the HSD array 204T is accessed prior to accessing the cache array 202T and the HSVC array 206T in parallel. The HSVC array 206T behaves as a virtual extension of the hot sets of the cache array 202T. That is, the size of the cache array 202T allocated to the hot sets is increased.

As shown at block 502 of FIG. 5, the method 500 includes receiving an address (e.g., address X shown in FIG. 2) which is mapped to the cache array 202T as describe above in FIG. 4.

As shown at block 504 of FIG. 5, the method 500 includes searching for the address in the HSD array 204T. For example, when the address is received, the HSD array 204T is searched, since it is fully associative, using the index bits of the address.

As shown at decision block 506 of FIG. 5, the method 500 includes determining whether there is an HSD hit. When the index bits of the address match the index bits of an entry stored in the HSD array 204T, an HSD hit occurs, and it is determined that the received address belongs to a hot set in the cache array 202T. The counter of the kth HSD entry is incremented.

When an HSD hit does not occur (i.e. HSD miss), the cache array 202T is accessed to search for the address in the cache array 202T, but the HSVC array 206T is not accessed (e.g., the address is not searched for in the HSVC array 206T), as shown at block 508 in FIG. 5. Each HSD entry counter is decremented. If a counter reaches the zero value, the set to which the new address is mapped enters that HSD entry and the counter corresponding to the set is incremented.

As shown at decision block 510 of FIG. 5, the method 500 includes determining whether there is a cache hit. When a cache hit occurs, the data is returned from the cache array 202T to the requestor, as shown in block 512. The replacement logic for the cache array 202T set is updated. When a cache hit does not occur, the data is searched for in the next level cache (if available), as shown in block 514. The data is then returned to the requestor and it is also installed in the cache array 202T.

When an HSD hit does occur, both the cache array 202T and the HSVC array 206T are accessed in parallel, as shown at blocks 516 and 518 in FIG. 5, to search for the address in both the cache array 202T and the HSVC array 206T. Further the counter of the kth HSD entry is incremented.

When the cache array 202T and HSVC array 206T are accessed in parallel, a unified replacement array is provided that includes N+M associativity, where N is the number of lines per set for the cache array 202T and M is the number of lines per set for the HSVC array 206T. Accordingly, the same replacement policy is applied to both the HSVC array and cache array. The M number of lines and N number of lines is equal or different.

Each entry of the unified replacement array can use (log2(N+M)) number of replacement bits, assuming a least recently used (LRU) replacement. The highest order replacement bit indicates whether the data is in the cache array 202T or the HSVC array 206T. Victims to the next level cache are generated either from the cache array 202T or the HSVC array 206T based on the specific replacement policy.

Given the unified replacement array organization, bits are stored to accommodate replacement of the additional HSVC lines in every cache set of array 202T, even when the HSVC array 206T is smaller than the cache array 206T. The HSVC array 206T does not behave like a victim cache, but rather as a cache hot set extension. The HSVC array 206T is not accessed on cold sets (HSD misses), but rather on hot ones (HSD hits). When an HSD entry is replaced, the lines of the HSVC set that belong to the top N entries of the unified replacement stack are promoted to the cache array 202T and the remaining HSVC lines are victimized to the next level cache if they are modified or if it is required based on the inclusion properties of the next level cache. The lines of the cache's set that belong to the bottom M lines of the unified replacement stack are also victimized (e.g., to the next level cache if available or to main memory) under the same conditions as the victimized HSVC lines. M lines are victimized to the next level of cache or to main memory, each time a HSD entry is replaced. M lines are promoted from the set of the HSVC array 206T to the cache array 202T each time a HSD entry is replaced.

Referring back to FIG. 5, as shown at decision block 520 of FIG. 5, the method 500 includes determining whether there is a cache hit and an HSVC hit. When it is determined that the address is in either the cache array 202T portion or the HSVC array 206T portion of the unified array, the data is returned from the unified array to the requestor, as shown at block 522 in FIG. 5. The unified replacement array is then updated allowing the line that provided the data to be promoted in the replacement stack.

When it is determined that the address is not in either the cache array 202T portion or the HSVC array 206T portion of the unified array, the data is returned from the next level cache or main memory, as shown at block 524 in FIG. 5. The data is also installed in the cache array 202T and the unified replacement stack is updated.

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors are manufactured by configuring a manufacturing process using the results of processed hardware description language (HDL) instructions and other intermediary data including netlists (such instructions capable of being stored on a computer readable media). The results of such processing are maskworks that are then used in a semiconductor manufacturing process to manufacture a processor which implements methods of accessing data using cache hot set detection.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method of accessing data using cache hot set detection, the method comprising:
receiving a plurality of requests to access data in a cache comprising a plurality of cache sets each including N number of cache lines, each request comprising an address; and
storing, in a hot set victim cache (HSVC) array, cache line victims of one or more of the plurality of cache sets determined to be hot sets, each cache line victim comprising a corresponding address determined, using a hot set detector (HSD) array, to belong to the one or more determined cache hot sets based on a hot set frequency of a plurality of addresses mapped to the set in the cache.

2. The method of claim 1, wherein the HSD array and the cache are accessed in parallel prior to accessing the HSVC array.

3. The method of claim 2, further comprising determining whether the corresponding address belongs to one of the plurality of cache sets in parallel with determining whether the corresponding address belongs to a determined hot set in the cache.

4. The method of claim 3, wherein the corresponding address is determined to belong to a determined hot set in the cache when the index bits of the corresponding address match the index bits of an entry stored in the HSD array.

5. The method of claim 3, wherein,
when it is determined that the corresponding address is in the cache array, the data is returned from the cache array to the requestor without accessing the HSVC array; and
when it is determined that the corresponding address belongs to a determined hot set in the cache, a counter for a HSD entry including the corresponding address is changed.

6. The method of claim 3, wherein the HSVC array is not accessed when it is determined that the corresponding address is not in the cache array and the corresponding address does not belong to a determined hot set in the cache.

7. The method of claim 3, further comprising determining whether the corresponding address is in the HSVC array when it is determined that the corresponding address is not in the cache array and the corresponding address does belong to a determined hot set in the cache.

8. The method of claim 7, wherein when the corresponding address is in the HSVC array, the data is returned from the HSVC array.

9. The method of claim 1, wherein the HSD array is accessed prior to accessing the cache and the HSVC array in parallel and the cache and the HSVC array are combined to provide a unified replacement array.

10. The method of claim 9, wherein the data is returned from the unified array when it is determined that the corresponding address is in the cache array or in the HSVC array.

11. The method of claim 1, wherein the set is determined to be a hot set by using a bounded number of counters each corresponding to one of a plurality of entries in the HSD depending on a hot set frequency threshold value.

12. A processing apparatus, comprising:
memory comprising:
a cache having a plurality of cache sets each including N number of cache lines;
a hot set detector (HSD) array;
a hot set victim cache (HSVC) array; and
one or more processors in communication with the memory and configured to:
receive a plurality of requests, each comprising an address, to access data in the cache;
store, in the HSVC array, cache line victims of one or more of the plurality of cache sets determined to be hot sets, each cache line victim comprising a corresponding address that is determined, using the HSD array, to belong to the one or more determined cache hot sets based on a hot set frequency of a plurality of requested addresses mapped to the set in the cache.

13. The processing apparatus of claim 12, wherein the one or more processors are further configured to dynamically configure the HSD array to determine whether the corresponding address belongs to the one or more determined cache hot sets using a bounded number of HSD entries that depend on a hot set frequency threshold value.

14. The processing apparatus of claim 12, wherein the one or more processors are further configured to access the HSD array and the cache in parallel prior to accessing the HSVC array.

15. The processing apparatus of claim 12, wherein
the HSD array comprises a plurality of entries each including a portion holding index bits of addresses mapped to the cache, and
the one or more processors are further configured to determine the corresponding address to belong to a determined hot set in the cache when the index bits of the corresponding address match the index bits of one of the plurality of entries of the HSD array.

16. The processing apparatus of claim 15, wherein
each of the plurality of entries of the HSD array further include an N-bit counter,
the one or more processors are further configured to:
return the data from the cache array to the requestor without accessing the HSVC array when it is determined that the corresponding address is in the cache array,
change an N-bit counter corresponding to an HSD entry when it is determined that the corresponding address belongs to a determined hot set in the cache; and
change each of the N-bit counters when it is determined that the corresponding address does not belong to a determined hot set in the cache.

17. The processing apparatus of claim 12, wherein the one or more processors are further configured to determine whether the corresponding address is in the HSVC array when it is determined that the corresponding address is not in the cache array and does belong to a determined hot set in the cache.

18. The processing apparatus of claim 12, wherein the one or more processors are further configured to:
access the HSD array prior to accessing the cache and the HSVC array in parallel; and
return the data from either the cache or the HSVC array when it is determined that the corresponding address is in the cache array or the HSVC array.

19. The processing apparatus of claim 12, wherein the one or more processors are further configured to access a unified replacement array comprising a number of entries equal to an associativity of the cache and the HSVC array.

20. A tangible, non-transitory computer readable medium comprising instructions for causing a computer to execute a method of accessing data using cache hot set detection, the instructions comprising:
receiving a plurality of requests to access data in a cache comprising a plurality of cache sets each including N number of cache lines, each request comprising an address; and
storing, in a hot set victim cache (HSVC) array, cache line victims of one or more of the plurality of cache sets determined to be hot sets, each cache line victim comprising a corresponding address determined, using a hot set detector (HSD) array, to belong to the one or more determined cache hot sets based on a hot set frequency of a plurality of addresses mapped to the set in the cache.
